(19) United States
(12) Patent Application Publication
(10) Pub. No.: US 2007/0266868 A1
(43) Pub. Date: Nov. 22, 2007

(54) SCREEN PRINTING MACHINES

(75) Inventor: Otto Richard Eppinger, Braeside (AU)

Correspondence Address: Connolly Bove Lodge & Hutz LLP;Suite 800, 1990 M Street, N.W., Washington, DC, 20036, US

(73) Assignee: Reefdale PTY Ltd, Braeside (AU)

(21) Appl. No.: 11/747,334

(22) Filed: May 11, 2007

(30) Foreign Application Priority Data
May 16, 2006 (AU) 2006902593

(51) Int. Cl. B05C 17/08

(52) U.S. Cl. 101/126

(57) ABSTRACT

A quick release pallet for a screen printing machine in which the pallet for supporting an item to be screen printed having having a longitudinal axis a top surface for supporting a garment to be printed and an underneath portion for attachment to a pallet arm; a top plate of a porous material; and at least one key hole slot in the underneath portion of said pallet. The pallet arm supports the pallet along its longitudinal axis and has attachment means to cooperate with the underneath portion of the pallet. The attachment means comprises two fastening heads adapted to fit and slide in the slot in the underneath portion of the pallet and the fastening heads are able to be clamped against the slot to fix the pallet to the pallet arm. The advantages are that the pallet has no attachments and can be very quickly positioned and released. Because there are no screw holes in the top surface of the pallet it has a larger print area. The pallet can be modified to a vacuum pallet with a perforated or porous top plate.

This invention relates to improvements in screen printing machines particularly to the pallet and pallet arm constructions used in such machines.

### BACKGROUND OF THE INVENTION

Garments such as tee shirts are decorated using multi printing head, screen printing machines. The number of heads correspond to the number of colours to be printed. U.S. Pat. Nos. 3,795,189 and 5,031,527 disclose examples of the type of machines used in printing garments.

The garments are supported on a pallet, which in turn is supported, for registry with the printing head, on a pallet arm. The pallet is moved successively past the desired number of printing heads until the printing is complete. Different size garments require correspondingly different sized pallets. Usually pallets are of the same length but vary in width from a garment sleeve width to a large body width. This means that the pallets need to be removed from the pallet arms on a frequent basis.

The positioning of the pallet on its pallet arm needs to be precise and secure to ensure that registration with successive printing heads is maintained.

Conventionally one means of removably securing pallets to pallet arms has been to use 2 or 3 counter sunk screws at each end of the pallet. This is quite adequate in terms of registration accuracy and retention of alignment but involves extensive labour time to fit a new set of pallets to a machine.

U.S. Pat. No. 4,031,825 discloses a pallet which fits sleeve-like over the pallet arm and is held in place by springs in the side edges of the pallet arm. Even though the pallet appears to be simple it needs to be fabricated or machined extensively as does the pallet arm.

U.S. Pat. No. 5,592,877 in part discloses a pallet which can be installed and released quickly and utilises a pneumatic release mechanism to free the pallet. The pallet comprises two plates screwed together with the lower plate having lugs and slots that cooperate with recesses and a pin in the pallet arm to locate the pallet.

U.S. Pat. No. 6,237,488 discloses a quick release pallet having two registration notches at one end and a recessed edge at the other end for a toggle clip to lock the pallet in place.

Although these quick release arrangements are an improvement they do have short comings in terms of convenience and operator simplicity. Also they all involve additional manufacturing steps in preparing the pallets.

It is also desirable that a pallet be adapted for use with a vacuum system which creates a vacuum through the surface of the pallet to retain the garment in position during the printing process.

### BRIEF DESCRIPTION OF THE INVENTION

To this end the present invention provides, in a screen printing machine of the type having a pallet mounted on a pallet arm which is successively brought into registry with a series of printing heads the improvement comprising
a) a pallet having a longitudinal axis a top surface for supporting a garment to be printed and an underneath portion for attachment to a pallet arm;
b) a pallet arm to support said pallet along its longitudinal axis and having attachment means to cooperate with the underneath portion of the pallet;
c) at least one key hole slot in the underneath portion of said pallet;
d) and two fastening heads adapted to fit and slide in said slot in the underneath portion of said pallet
e) said fastening heads able to be clamped against the slot to fix the pallet to the pallet arm

The pallet of this invention has no fixing holes or recesses in its upper surface enabling the whole of the upper surface to support a garment for printing.

The pallets can in other respects be of the same shape and materials as is conventional for screen printing pallets.

The slot or slots underneath the pallet are shaped to fit over a lug or bolt head protruding from the surface of the pallet arm. In order to press the pallet securely into its register position the final securing force may be provided by a toggle clamp acting on the lug or heads on the pallet arm.

To fit the pallet, it is simply placed onto the pallet arm so that the heads on the pallet arm are aligned with the slot or slots the pallet is pushed to its preferred location and then the toggle is locked into place. Only one fastening action is needed.

Because there are no screw or bolt holes in the top surface of the pallet, a larger surface area of the pallet is available for printing than is the case for prior art pallets. Because there are no protrusions or rails mounted on the pallet as is the case with prior art quick release pallets, the pallets of this invention pack flat and are easier to store, transport and clean.

In a modification of the pallet of this invention the pallet is adapted for use with a vacuum manifold. The pallet is formed in two parts the upper surface being perforated to enable air flow through the surface and the lower surface incorporating a recess communicating with a vacuum outlet connected to a manifold. The manifold may be a third part of the vacuum pallet or it can be a part of the pallet arm which mates with the pallet. Such arrangements are described in U.S. Pat. Nos. 6,575,091 and 6,789,473.

### DETAILED DESCRIPTION OF THE INVENTION

A preferred embodiment of this invention will now be described with reference to the drawings in which:

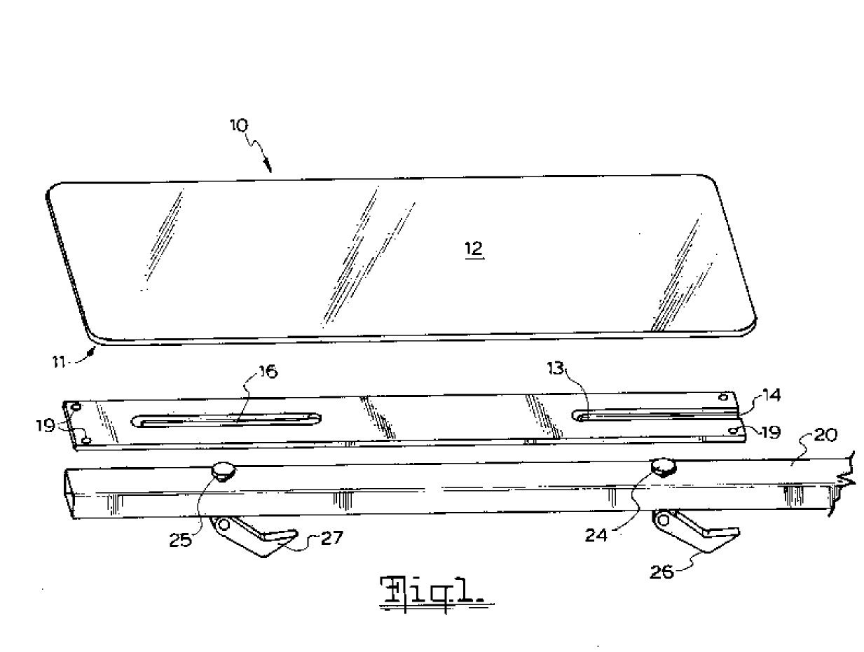

FIG. 1 is an exploded view of the pallet arm and pallet of this invention;

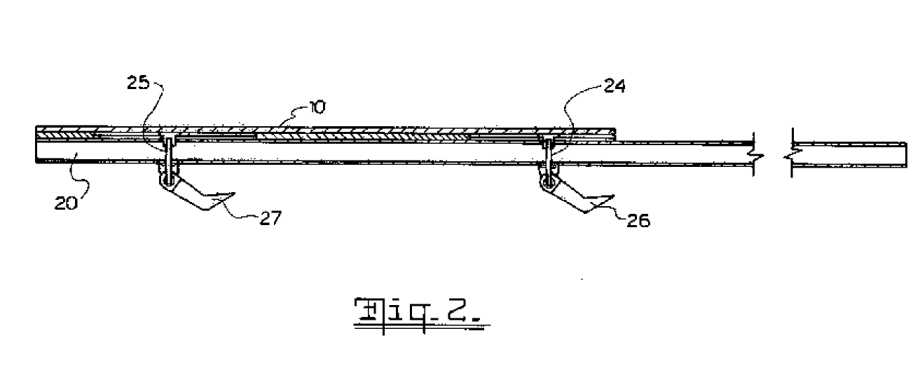

FIG. 2 is a side view of the pallet fastened to the pallet arm;

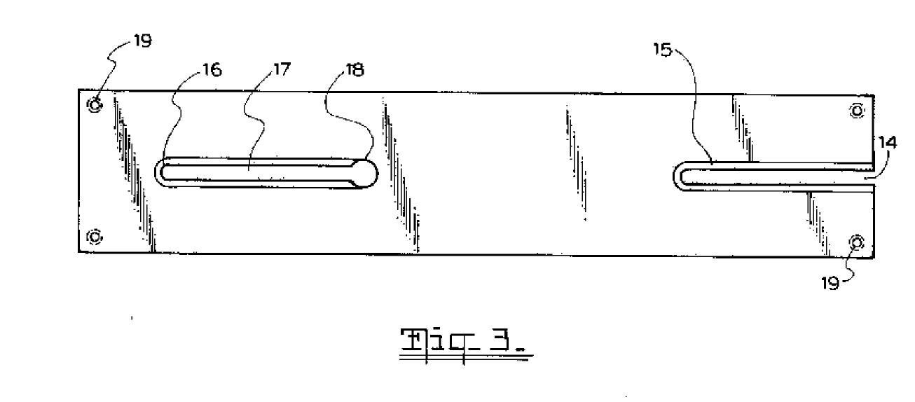

FIG. 3 is an underneath plan view of the lower portion of the pallet of this invention;

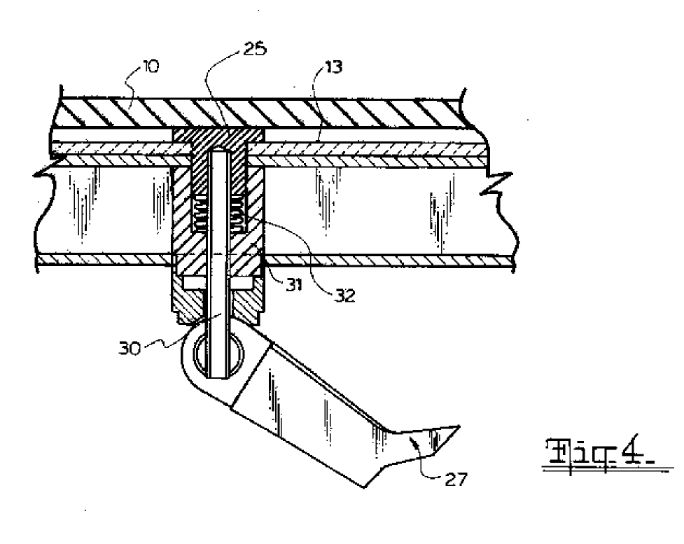

FIG. 4 is a detailed side view of a preferred toggle assembly according to the invention.

The pallet 10 is a flat aluminium cast plate of a size matched to the garment to be printed. The pallet has an upper surface 12 and a lower surface 11 to which an attachment plate or underlay 13 is attached by way of screws at points 19 in each corner. Alternatively the underlay 13 may be adhered to the surface 11 of the pallet. The underlay 13 incorporates a first slot 14 commencing in an end edge of the underlay and a second slot 16 located longitudinally in line with slot 14 toward the opposed edge of the underlay 13. Each of slots 14 and 16 include recessed edges 15 and 17. The second slot (16) has an opening 18 at the end closest to slot 14 to allow the bolt head 25 to be introduced into the slot 16.

An alternative pallet arrangement uses a continuous slot formed in the under surface of the pallet, instead of two separate slots. Such a pallet can be formed in one piece by extrusion and avoids the need for machining or assembly of an underlay to the pallet body.

The pallet arm 20 has an upper surface 21 and a side portion 22. Counter sunk bolt heads 24, 25 protrude from the upper surface 21 of the pallet arm 20. On the under sides of the heads 24, 25 are inclined faces which engage the edges 15, 17 of the slots 14, 16 in underlay 13. Associated with the bolt heads 24, 25 are the toggles 26, 27 which act to press the heads 24,25 against the edges 15, 17 to secure the pallet in position.

A preferred toggle assembly is shown in FIG. 4. The lever 27 acts on the shaft 30 to which the head 25 is attached. A compression spring 32 is inserted between the head 25 and a spacer 31 to provide a spring loaded locking arrangement.

To assemble a pallet to a pallet arm the pallet is centered on the pallet arm so that the slots 14 and 16 are on the remote side of the heads 24, 25 and then pulled toward the free end of the pallet arm. To lock the pallet to the arm the toggles 26, 27 are actuated.

From the above description it can be seen that this invention provides
1) a pallet that is simple to manufacture.
2) The pallet is simple to assemble to the pallet arm.
3) The pallet has a larger free surface for printing because there are no screw holes through its top surface
4) The pallet and arm can be made from off the shelf components which reduces the costs of production.

The pallet may be adapted for use with a vacuum line as described in U.S. Pat. Nos. 6,575,091 and 6,789,473.

Those skilled in the art will appreciate that this invention can be implemented in embodiments other than those described without departing from the core teachings of this invention.

1. In a screen printing machine of the type having a pallet mounted on a pallet arm which is successively brought into registry with a series of printing heads the improvement comprising
a) a pallet having a longitudinal axis, a top surface for supporting a garment to be printed and an underneath portion for attachment to a pallet arm;
b) a pallet arm to support said pallet along its longitudinal axis and having attachment means to cooperate with the underneath portion of the pallet;
c) at least one slot in the underneath portion of said pallet;
d) and two fastening heads adapted to fit and slide in said slot in the underneath portion of said pallet
e) said fastening heads able to be clamped against the slot to fix the pallet to the pallet arm

2. A pallet for supporting an item to be screen printed having
a) having a longitudinal axis, a top surface for supporting a garment to be printed and an underneath portion for attachment to a pallet arm;
b) at least one slot in the underneath portion of said pallet.

3. A pallet arm as claimed in claim 2 in which there is one continuous slot in the underneath surface of said pallet.

4. A pallet arm as claimed in claim 3 which is formed by extrusion.
